(19) United States
(12) Patent Application Publication
(10) Pub. No.: US 2004/0176035 A1
(43) Pub. Date: Sep. 9, 2004

(54) Envelope cancellation in an RF circuit

(76) Inventor: Brian C. Breunig, Lake in the Hills, IL (US)

Correspondence Address: MOTOROLA, INC., 1303 EAST ALGONQUIN ROAD, IL01/3RD, SCHAUMBURG, IL, 60196

(21) Appl. No.: 10/366,765

(22) Filed: Feb. 14, 2003

(51) Int. Cl. H04B 1/10; H04B 15/00; H04B 17/00

(52) U.S. Cl. 455/63.1; 455/67.13

(57) ABSTRACT

Envelope cancellation by an RF detector circuit (140) that includes the steps of: (410) receiving an RF input signal having a given magnitude, the RF input signal including an input envelope signal having a first frequency modulated on top of a carrier signal having a second frequency; (420) generating a first rectified signal including a first direct current (DC) component that corresponds to the magnitude of the RF input signal and a first modified envelope component that is proportional to the input envelope signal; (430) generating a second rectified signal including a second DC component that corresponds to the magnitude of the RF input signal and a second modified envelope component that is proportional to the input envelope signal; and (440) removing the first and second modified envelope components and the second DC component to generate an output signal from the detector circuit.

### FIELD OF THE INVENTION

The present invention relates generally to radio frequency (RF) circuits and, more specifically, to a method and circuit for canceling an envelope component from the output signal of a detector circuit.

### BACKGROUND OF THE INVENTION

RF circuits, e.g., RF power amplifiers (“PAs”), are used in a wide variety of communications and other electronic applications, such as two-way radios, wireless personal communication devices, and base station repeaters. RF power amplifiers are typically made up of one or more cascaded amplifier stages, each of which increases the level of the signal applied to the input of that stage by an amount known as the gain stage.

FIG. 1 illustrates a typical power amplifier circuit 100. Circuit 100 includes a controller integrated circuit (IC) 104, a PA 110, a coupler 120, an antenna 130 and a detector circuit 140. For simplicity of illustration, circuit 100 includes a single amplifier stage, but it is realized by those of ordinary skill in the art that circuit 100 would typically include a plurality of cascaded amplifier stages. Circuit 100 functions as follows. Controller IC 104 controls an input power signal (illustrated as a solid line 102) into PA 110. PA 110 amplifies signal 102 to generate a PA output power signal (illustrated as a solid line 112) that is coupled to antenna 130 via coupler 120 for transmitting signal 112. Coupler 120 samples off a portion of 112 (illustrated as solid line 122) and detector circuit 140 rectifies signal 122 to generate an output voltage signal (illustrated as a solid line 150). The purpose of signal 150 is to provide an indication to the controller IC 104 of the level (or strength) of the PA output power signal 112, so that controller IC 104 may adjust the PA input power signal 102, as necessary to maintain the current output power level.

Typically in applications using circuit 100, it is important that the PA output power signal 112 be maintained at a constant predetermined level. Therefore, it is important that the detector circuit output voltage signal 150 accurately reflect the output power signal level 112. In typical applications, signals 102, 112 and 122 are each complex modulated signals, i.e., each signal includes an envelope signal modulated on top of a carrier signal. In many applications, the frequency of the envelope signal is at least three orders of magnitude lower than the frequency of the carrier signal. For example, for Linear Simulcast Modulation the typical frequency range for a carrier signal could be in any frequency band allocated for public service. One common band is the VHF frequency band of 30-54 MHz. Here a 25 kHz bandwidth envelope signal may be modulated on top of a 30 MHz carrier, which will result in a bandwidth to carrier frequency ratio of 1200, or slightly larger then 3 orders of magnitude.

An example of a detector circuit 140 known in the art is illustrated in FIG. 2. This detector circuit 140 includes a Schottky diode 142 used to rectify signal 122 and generate a signal having a DC component that corresponds to and is proportionate to signal 122, thereby indicating the actual strength of signal 122, e.g., the actual output power level of PA 110. The detector circuit also optionally includes a voltage divider network 144 to adjust the DC component in accordance with the particular application or, alternatively, a resistor 144 to provide a stable ground reference for signal 150.

A problem with this circuit is that when a complex modulated signal such as signal 122 is passed through circuit 140, the resultant output signal 150 also comprises an envelope component (or term) that is a factor of the envelope component contained in signal 122. The envelope component of signal 122 typically has large peak to average ratios that can cause the output signal 150 to widely vary. FIG. 3 illustrates a waveform of voltage verses time for signal 150 generated by circuit 140 as illustrated in FIG. 2. In this example, signal 122 has an envelope component that has a frequency of about 40 kHz modulated on top of a carrier frequency that is about 500 MHz. As FIG. 3 illustrates, the voltage signal 150 has an average voltage of about 1.5 volts but varies over time between 0.6 volts and 2.4 volts. This wide voltage variation could cause controller IC 104 to detect a voltage level that does not reflect the actual PA output power level 112 if measures are not taken to filter out the envelope component of signal 150.

It is known in the art to use either additional hardware, e.g., a passive resistor and capacitor (RC) circuit, a software process, or a combination of hardware and software to filter out this envelope component such that signal 150 provides a more accurate indication of the actual PA 110 output power level. However, use of additional hardware and/or software results in a time delay before the actual power can be read because of the low envelope frequency. For instance, it currently takes about 250 msec (i.e., 25 samples at 10 msec spacing) to read output power using prior art filtering techniques. This results in an increased time to reach the desired power level for an RF device and an increased time to attain a desired coverage area. Such a time delay may be unacceptable in applications that require reduced key-up times in conjunction with increased accuracy in power level detection, such as high-speed data where data bursts are quick, around 10 msec. In addition, different modulation types may require different software and hardware filtering to result in optimum performance. Therefore, the same circuit may not work for all desired implementations, resulting in additional manpower and cost to determine the particular circuit for use in a given implementation. Moreover, as processing power and memory may be limited in certain applications, use of software filtering also creates additional software coding and loading that may prevent alternative functionality in an RF device.

Thus, there exists a need for a method and circuit for accurately detecting the PA output power level without the need for using software and with a minimum or no time delay.

### BRIEF DESCRIPTION OF THE FIGURES

A preferred embodiment of the invention is now described, by way of example only, with reference to the accompanying figures in which:

FIG. 1 illustrates a simple block diagram of a prior art power amplifier circuit;

FIG. 2 illustrates a diagram of a prior art circuit for detecting the output power level of the power amplifier circuit illustrated in FIG. 1;

FIG. 3 illustrates a waveform of voltage verses time for the output signal of the circuit illustrated in FIG. 2;

FIG. 4 illustrates a method for detecting the output power level of a power amplifier circuit in accordance with the present invention;

FIG. 5 illustrates a schematic diagram of a circuit in accordance with the present invention for detecting the output power level of the power amplifier circuit illustrated in FIG. 1; and

FIG. 6 is a waveform of voltage verses time for the output signal of the circuit illustrated in FIG. 5.

### DETAILED DESCRIPTION OF THE PREFERRED EMBODIMENT

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

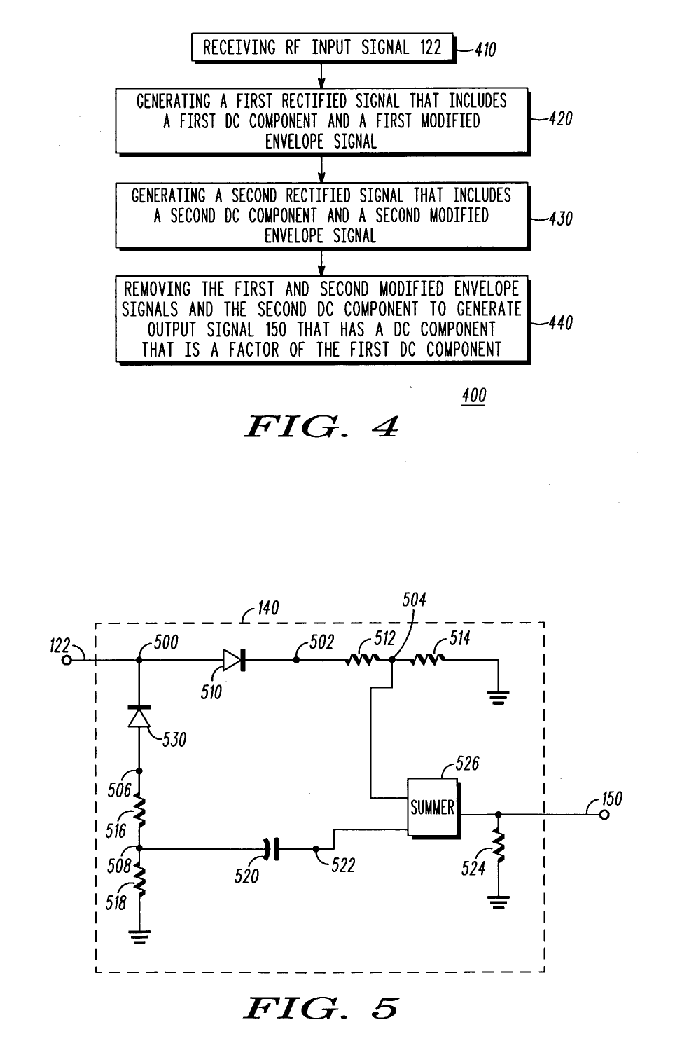

FIG. 4 illustrates a method 400 for detecting the output power level of a power amplifier circuit in accordance with the present invention. Method 400 includes the steps of: 410 receiving a signal 122 having a given signal strength (or magnitude); 420 generating a first rectified signal that includes a first DC component that corresponds to the actual strength of signal 122 and a first modified envelope component that is proportional to the envelope component contained in signal 122; 430 generating a second rectified signal that includes a second DC component that corresponds to the actual strength of signal 122 and a second modified envelope component that is proportional to the envelope component contained in signal 122; and 440 removing the first and second modified envelope components and the second DC component to generate signal 150 that has a DC component that is a factor of the first DC component, and thereby corresponds to the actual strength of signal 122.

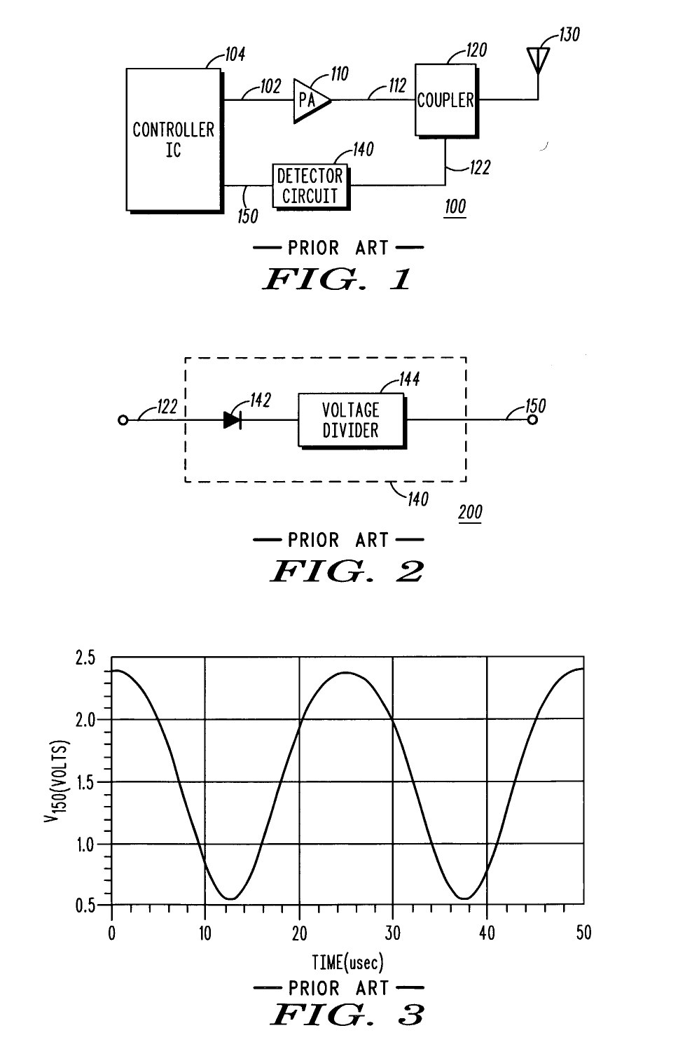

FIG. 5 illustrates a schematic diagram of a circuit 140 in accordance with the present invention for detecting the output power level of power amplifier 110 illustrated in FIG. 1. Circuit 140 utilizes the method illustrated in FIG. 4. Circuit 140 preferably includes a diode 510 and a diode 530 that are coupled in a cathode-to-anode fashion at a node 500. Preferably, diodes 510 and 530 are Schottky diodes. In addition, for reasons that are set forth below, diodes 510 and 530 are reasonably well matched (essentially identical), for instance, by being included on the same IC chip. Circuit 140 also preferably includes a voltage divider network coupled between a node 502 and ground that includes a resistor 512 and a resistor 514 and a voltage divider network coupled between a node 506 and ground that includes a resistor 516 and a resistor 518. Preferably both voltage divider networks are also reasonably well matched, thereby having essentially identical ratios. Circuit 140 of FIG. 5 further includes a capacitor 520 coupled between nodes 508 and 522 and a summer 526, which could be a summing operational amplifier or a simple resistive summing junction having its inputs at nodes 504 and 522 and an output at which signal 150 is generated. Finally, a resistor 524 is preferably connected between the summer output and ground for providing a stable ground reference for signal 150.

We next turn to the operation of circuit 140 in FIG. 5. Upon receipt of signal 122, diodes 510 and diode 530 rectify signal 122 as a function of the phase of signal 122. In this instance, diode 510 rectifies the positive phase of signal 122, and diode 530 rectifies the negative phase of signal 122. Each rectified signal contains a DC component proportional to signal 122 in that it corresponds to the signal strength or power level of signal 122. Each rectified signal further includes the components of: an envelope component that is proportional to the envelope component contained in signal 122; a carrier frequency component that is proportional to the carrier frequency component in signal 122; even order harmonics of the fundamental carrier frequency; and odd order harmonics of the fundamental carrier frequency. Because diodes 510 and 530 are connected cathode-to-anode, the DC component, envelope signal, carrier frequency component, and odd order harmonics contained in the rectified signal generated by diode 530 are the inverse of the respective components contained in the rectified signal generated by diode 510. Moreover, since diodes 510 and 530 are essentially identical, the respective magnitudes of each corresponding component in the rectified signals are essentially identical. Thus, the respective DC components of the rectified signals are essentially identical in magnitude, etc.

The voltage divider networks having resistors 512 and 514 and resistors 516 and 518, respectively, scale the respective components of the rectified signals in proportion to their respective ratios and in accordance with a given application. Since these ratios are essentially identical, the scaling of the components of the respective rectified signals is, thereby, essentially identical. Capacitor 520 then removes the DC component contained in the rectified signal generated by diode 530. In this embodiment a capacitor is used to remove the DC component. However, those of ordinary skill in the art will realize that other conventional implementations may be used for this functionality.

The resultant signals at nodes 522 and 504 are then added together to generate signal 150. It is important that diodes 510 and 530 be essentially identical and the voltage divider networks have essentially identical ratios so that the envelope signals in the respective rectified signals cancel out to eliminate the effect that these signals might have on the accuracy of signal 150 to indicate the strength of signal 122. All other components in the respective rectified signals that are the inverse of each other will likewise be cancelled. In addition, the value of capacitor 520 is selected to maximize the removal of the DC component without altering the envelope component. This is preferably achieved by selecting capacitor 520 to provide a high pass filter effect with a corner frequency below that of the envelope component so that the envelope component passes unaffected. Therefore, when the signals at nodes 522 and 504 are added together maximum cancellation of the respective envelope components is achieved.

Thus, the resultant signal 150 will have a DC component, which is a factor of the DC component generated by diode 510, and that indicates the actual strength of signal 122. Signal 150 will also have even order harmonics that are twice the amplitude of the even order harmonics contained in either of the signals at nodes 504 and 522. The remaining even order harmonics are, however, of such a minimum variation in amplitude such that, even without the use of additional filtering techniques, circuit 140 detects the actual magnitude of signal 122 with an increased accuracy than that obtainable in the prior art.

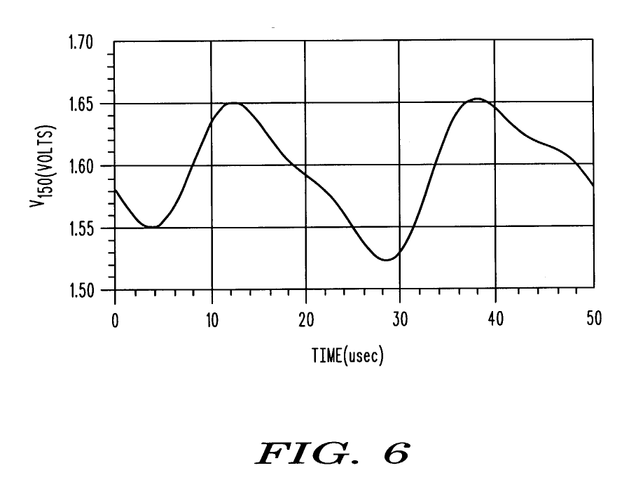

FIG. 6 is a waveform of voltage verses time for signal 150 generated by circuit 140 as illustrated in FIG. 5. The waveform in FIG. 6 was generated using the same conditions as those used in generating the waveform illustrated in FIG. 3, i.e., signal 122 has an envelope component that has a frequency of about 40 kHz modulated on top of a carrier frequency that is about 500 MHz. In addition, a capacitor value of 10 μF was selected to maximize envelope cancellation. As can be seen, the average value out of signal 150 over time is about 1.59 volts and only varies between about 1.53 volts and 1.65 volts over time. This relatively minimal variation in output voltage is in large part a result of the even order harmonics being present in the output voltage at double the magnitude, and the variation may also in part be caused by non-ideal envelope cancellation. However, additional circuitry may be added to further filter out the even order harmonics. This filtering can be easily and quickly accomplished using a passive RC circuit because the frequency of the even order harmonics are at least on the order of four magnitudes higher than the envelope frequency. For instance, using conventional noise filtering techniques alone, the actual output power level may be read using an embodiment of the present invention in about 1.5 msec (e.g., 3 samples at 0.5 msec spacing). This is an improvement of greater than 100 times over the prior art.

A first advantage of the present invention is its reduced filtering requirements.

Another advantage of the present invention is that it enables an RF circuit to reach a desired power level in a quicker amount of time as compared to the prior art, thereby enabling a desired coverage area to be more quickly obtained.

A further advantage of the present invention is that the circuit may be used across a wider range of modulation types because the need for envelope specific filtering is eliminated.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. A method for envelope cancellation in an RF circuit, said method comprising the steps of:
receiving an RF input signal having a given magnitude, said RF input signal comprising an input envelope signal having a first frequency modulated on top of a carrier signal having a second frequency;
generating a first rectified signal comprising a first direct current (DC) component that corresponds to the magnitude of said RF input signal and a first modified envelope component that is proportional to said input envelope signal;
generating a second rectified signal comprising a second DC component that corresponds to the magnitude of said RF input signal and a second modified envelope component that is proportional to said input envelope signal;
removing said first and second modified envelope components and said second DC component to generate an output signal having a DC component that is a factor of said first DC component.

2. The method of claim 1, wherein said second DC component is removed using a passive high pass filter.

3. The method of claim 2, wherein said passive filter has a corner frequency below that of said first frequency.

4. The method of claim 1, wherein said second modified envelope component is the inverse of said first modified envelope component and said first and second modified envelope components are removed by adding said modified envelope components together.

5. The method of claim 4, wherein said first rectified signal is generating using a first diode and said second rectified signal is generated using a second diode that is essentially identical to said first diode and that is connected cathode-to-anode to said first diode for causing said second modified envelope component to be the inverse of said first modified envelope component.

6. The method of claim 1, wherein said first rectified signal further comprises first odd order harmonics and said second rectified signal further comprises second odd order harmonics, said method further comprising the step of removing said first and second odd order harmonics.

7. The method of claim 1, wherein said second odd order harmonics is the inverse of said first odd order harmonics and said first and second odd order harmonics are removed by adding them together.

8. The method of claim 1 wherein first frequency is at least 3 orders of magnitude lower than said second frequency.

9. A method for envelope cancellation in an RF circuit, said method comprising the steps of:
receiving an RF input signal having a given magnitude, said RF input signal comprising an input envelope signal having a first frequency modulated on top of a carrier signal having a second frequency;
generating a first rectified signal comprising a first direct current (DC) component that corresponds to the magnitude of said RF input signal and a first modified envelope component that is proportional to said input envelope signal;
generating a second rectified signal comprising a second DC component that corresponds to the magnitude of said RF input signal and a second modified envelope component that is proportional to said input envelope signal and that is the inverse of said first modified envelope component;
removing said first and second modified envelope components by adding them together and removing said second DC component to generate an output signal having a DC component that is a factor of said first DC component.
